(19) United States
(12) Patent Application Publication
(10) Pub. No.: US 2022/0108153 A1
(43) Pub. Date: Apr. 7, 2022

(54) BAYESIAN CONTEXT AGGREGATION FOR NEURAL PROCESSES

(71) Applicant: Robert Bosch GmbH, Stuttgart (DE)

(72) Inventors: Gerhard Neumann, Karlsruhe (DE); Michael Volpp, Stuttgart (DE)

(21) Appl. No.: 17/446,676

(22) Filed: Sep. 1, 2021

(30) Foreign Application Priority Data
Oct. 2, 2020 (DE) 102020212502.3

(51) Int. Cl. G06N 3/04; G06K 9/62; G06N 5/04

(52) U.S. Cl. CPC G06N 3/0472; G06N 5/04; G06K 9/6256; G06N 3/0454

(57) ABSTRACT

A method for generating a computer-implemented machine learning system. The method includes receiving a training data set, which corresponds to a dynamic response of a device, and computing an aggregation of at least one latent variable of the machine learning system, using Bayesian inference, and in view of the training data set. An information item contained in the training data set is transferred directly into a statistical description of the plurality of latent variables. The method further includes generating an a-posteriori predictive distribution for predicting the dynamic response of the device, using the calculated aggregation, and under the condition that the training data set has set in.

### CROSS REFERENCE

The present application claims the benefit under 35 U.S.C. § 119 of German Patent Application No. DE 102020212502.3 filed on Oct. 2, 2020, which is expressly incorporated herein by reference in its entirety.

### FIELD

The present invention relates to computer-implemented methods for generating a computer-implemented machine learning system for a technical device.

### BACKGROUND INFORMATION

The development of powerful computer-implemented models for deriving quantitative relationships between variables from measurement data is of central importance in all branches of engineering. In this connection, computer-implemented neural networks and methods, which are based on Gaussian processes, are being used increasingly in various technical environments. Neural networks are able to cope well with large amounts of training data sets and are computationally efficient at the training time. One disadvantage is that they do not supply any estimates of uncertainty over their predictions, and in addition, they may tend to overfit in the case of small data sets. Furthermore, there may be the problem that for their successful use, neural networks should be highly structured, and that at or above a certain level of complexity of the applications, their size may increase rapidly. This may place overly high demands on the hardware necessary for using the neural networks. Gaussian processes may be regarded as complementary to neural networks, since they may supply reliable estimates of the uncertainty, but with the number of context data during the training time, their, e.g., quadratic or cubic scaling may severely limit use on typical hardware in the case of tasks having large volumes of data or in multidimensional problems.

In order to address the problems mentioned above, methods have been developed, which relate to so-called neural processes. These neural processes may combine the advantages of neural networks and Gaussian processes. Finally, they provide a distribution over functions (instead of one single function) and constitute a multi-task learning method (that is, the method is trained for several tasks simultaneously). In addition, these methods are based, as a rule, on conditional latent variable (CLV) models, where the latent variable is used for taking into account the global uncertainty.

The computer-implemented machine learning systems may be used, e.g., for parameterizing technical devices (e.g., for parameterizing a characteristics map). A further scope of application of these methods includes smaller technical devices having limited hardware resources, in which the power consumption or the low storage capacity may limit considerably the use of larger neural networks or a method based on Gaussian processes.

### SUMMARY

The present invention relates to a computer-implemented method for generating a computer-implemented machine learning system. In accordance with an example embodiment of the present invention, the method includes receiving a training data set x_{c}, y_{c}, which reflects a dynamic response of a device, and computing an aggregation of at least one latent variable z₁ of the machine learning system, using Bayesian inference, and in view of training data set xc, yc. An information item contained in the training data set is transferred directly into a statistical description of the plurality of latent variables zₗ. The method further includes generating an a-posteriori predictive distribution p(y|x,D^{c}) for predicting the dynamic response of the device, using the calculated aggregation, and under the condition that training data set x_{c}, y_{c} has set in.

The present invention also relates to the use of the generated, computer-implemented machine learning system in different technical environments. The present invention further relates to generating a computer-implemented machine learning system and/or using a computer-implemented machine learning system for a device.

The techniques of the present invention are directed towards generating a computer-implemented machine learning system, which is (as) simple and efficient (as possible), provides an improved predictive performance and accuracy in comparison with some methods of the related art, and additionally has an advantage with regard to computational costs. For this purpose, the computer-implemented machine learning system may be trained by machine on the basis of available data sets (e.g., historical data). These data sets may be obtained from a generally given family of functions, using a given subset of functions from this family of functions, which are computed at known data points.

In particular, a disadvantage of a mean aggregation of some techniques of the related art, in which each latent observation of the machine learning system may be assigned the same weight 1/N (regardless of the amount of information, which is contained in the corresponding context data pair), may be circumvented. The techniques of the present description are directed towards improving the aggregation step of the method, in order to generate an efficient computer-implemented machine learning system and to reduce the computational costs resulting from it. The computer-implemented machine learning systems generated in this manner may be used in numerous technical systems. For example, a technical device may be designed with the aid of the computer-implemented machine learning systems (e.g., modeling the parameterization of a characteristics map for a device, such as an engine, a compressor, or a fuel cell).

### BRIEF DESCRIPTION OF THE DRAWINGS

FIG. 1a schematically shows the conditional latent variable (CLV) model, including task-specific latent variables zₗ and a task-independent latent variable θ, which covers the common statistical structure between the tasks. The variables in circles correspond to the variables of the CLV model: [symbol] ₗ^{c}≡{x_{l,n}^{c},y_{l,n}^{c}}ₙ₌₁^{N}^{ₗ} and [symbol] ₗ^{t}≡{x_{l,n}^{t},y_{l,n}^{t}}ₘ₌₁^{M}^{ₗ} are the context (c) and target data sets (t), respectively.

FIG. 1b schematically shows a network including mean aggregation (MA) of the related art, along with the likelihood variation method (VI), which are used in CLV models. For the sake of simplicity, task indices l are omitted. Each context data pair (xₙ^{c},yₙ) is mapped by a neural network onto a corresponding latent observation rₙ·r̅ is an aggregated latent observation, r̅=1/N·Σₙ₌₁^{N}rₙ (mean). Boxes, which are labeled with a·[b], denote multilayer perceptrons (MLP) including a hidden layers that each have b units. The box having the designation “mean” denotes traditional mean aggregation. The box, which is labeled with z, denotes the implementation of a random variable having a random distribution, which is parameterized by parameters that are given by the incoming nodes. d_{z} corresponds to the latent dimension, zₗ∈ [symbol] ^{d}^{_{z}}, and xₙ^{t} are defined in the heading of FIG. 1a.

FIG. 2 shows a network having the “Bayesian aggregation” of the present description. For the sake of simplicity, task indices l are omitted. The box having the designation “Bayes” denotes the “Bayesian aggregation.” In one example, in addition to the mapping by a neural network introduced in FIG. 1b, each context data pair (xₙ^{c},yₙ^{c}) may be mapped by a second neural network onto an uncertainty (σᵣ_{ₙ}²) of the corresponding latent observation (rₙ). In this example, parameters (μ_{z};σ_{z}²) parameterize the approximate a-posteriori distribution q_{φ}(z| [symbol] ^{c}). The other notations correspond to the notations used in FIG. 1b. The aggregated latent observation r̅ defined in FIG. 1b is not used.

FIG. 3 compares the results for a test data set (the Furuta pendulum), which were calculated for different methods, and shows logarithms of the a-posteriori predictive distribution, log p(y|x, [symbol] ^{c}), as a function of the number of context data points N. BA+PB: numerical results, using the “Bayesian aggregation” (BA) of the present invention shown in FIG. 2 and the non-stochastic, parameter-based loss function (PB) of the present invention, which replaces the traditional variational-inference-based or Monte-Carlo-based methods. MA+PB: numerical results, using the traditional mean aggregation sketched in FIG. 1b and the loss function PB of the present invention. BA+VI: numerical results, using the BA of the present invention and the traditional loss function, which is approximated by the likelihood variation method. L corresponds to the number of training data sets.

### DETAILED DESCRIPTION OF EXAMPLE EMBODIMENTS

The present description relates to the method for generating a computer-implemented machine learning system (e.g., a probabilistic regressor or classifier) for a device, which is generated, using aggregation by Bayesian inference (“Bayesian aggregation”). Due to its computational complexity, this method is executed in a computer-implemented system. Several general aspects of the method for generating a computer-implemented machine learning system are initially discussed, before some possible implementations are subsequently explained.

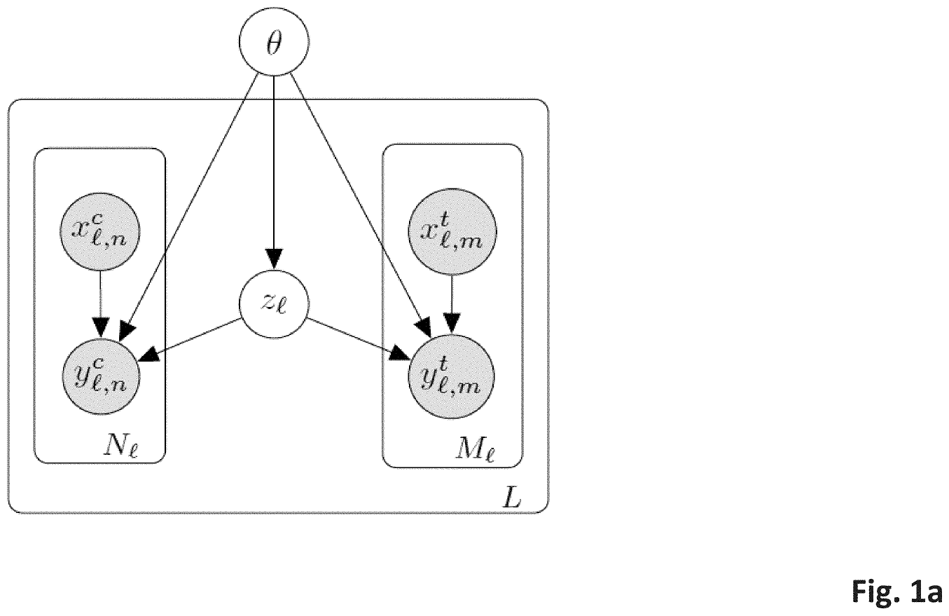

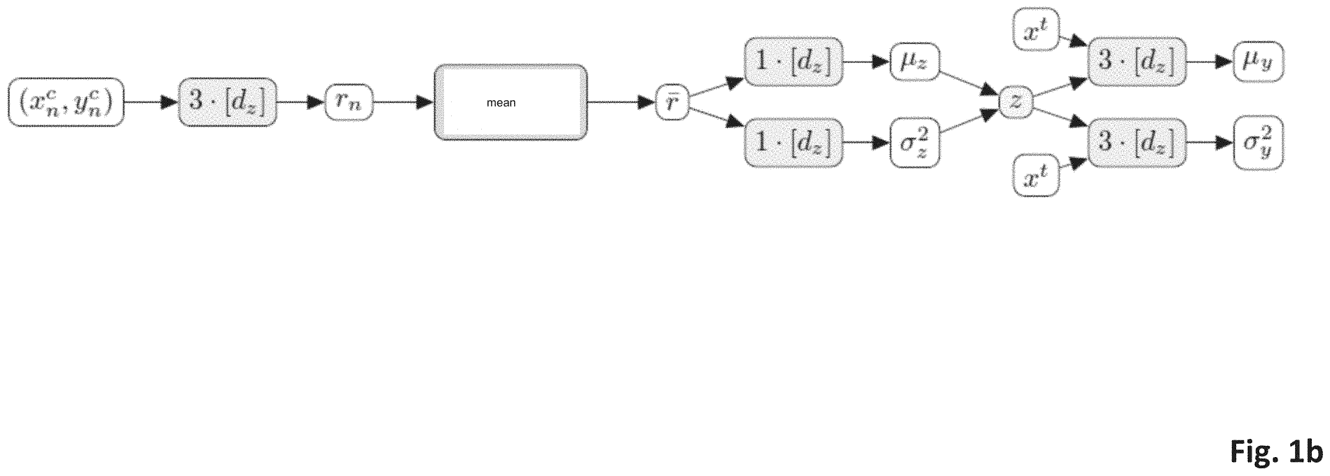

In particular, the probabilistic models in connection with neural processes may be formulated schematically as follows. A family of general functions ƒₗ, which may be used for a specific technical problem, and which have a similar statistical structure, is designated by [symbol] . It is also assumed that data sets [symbol] ₗ≡{x_{l,i},y_{l,i}}ᵢ used for the training are available; y_{l,i} being calculated from the above-mentioned family of functions at data points x_{l,i} as follows, using the subset of L functions (“tasks”) {ƒₗ}ₗ₌₁^{L}, ⊂ [symbol] : y_{l,i}=ƒₗ(xᵤ)+ε. In this case, is additive Gaussian noise having a mean of zero. As illustrated in FIG. 1a, data sets Dₗ≡{x_{l,i},y_{l,i}}ᵢ, are subsequently subdivided into context data sets [symbol] ₗ≡{x_{l,n}^{c},y_{l,n}^{c}}ₙ₌₁^{N}^{ₗ} and target data sets [symbol] ₗ^{t}≡{x_{l,m}^{t},y_{l,m}^{t}}ₘ₌₁^{M}^{ₗ}. The method based on neural processes aims to train an a-posteriori, predictive distribution p(y_{l,m}^{t}|x_{l,m}^{t}, [symbol] ₗ^{c}) over ƒₗ (under the condition that context data set [symbol] ₗ^{c} has set in), in order to predict target values y_{l,m}^{t} at target points x_{l,m}^{t} as accurately as possible (e.g., with an error, which lies below a predetermined threshold value).

As mentioned above and shown in FIG. 1a, this method may additionally include using models having conditional latent variables (CLV variables). Specifically, this model may include task-specific latent variables zₗ, as well as at least one task-independent latent variable (e.g., a task-independent latent variable θ), which covers the common statistical structure between the tasks. Latent variables zₗ are random variables, which contribute to a probabilistic character of the entire method. In addition, latent variables zₗ are needed for transferring the information contained in the context data sets (left box in FIG. 1a), in order to be able to make corresponding predictions about the target data sets (right boxes in FIG. 1a). The entire method may be relatively complex computationally and may be made up of several intermediate steps. The method may be represented as an optimization problem, in that an a-posteriori, predictive likelihood distribution is maximized with regard to the at least one task-independent latent variable θ and to a single set of parameters φ, which parameterizes the approximate a-posteriori distribution q_{φ}(z| [symbol] ^{c}) and is common to context data sets [symbol] ₗ^{c}. At the same time, all of the distributions that are a function of latent variables zₗ are correspondingly marginalized, that is, integrated with respect to zₗ. Finally, desired a-posteriori, predictive distribution p(y_{l,m}^{t}|x_{l,m}^{t}, [symbol] ₗ^{c}) may be derived.

Since zₗ is a latent variable, a form of aggregation mechanism is necessary, in order to allow the use of context data sets [symbol] ₗ^{c} of variable size. In order to be able to constitute a useful operation on data sets, such an aggregation must be invariant with regard to the permutations of context data points x_{l,n}^{c} and y_{l,n}^{c}. In order to satisfy this permutation condition, the traditional mean aggregation schematically represented in FIG. 1b is normally used. Initially, each context data pair (xₙ^{c},yₙ^{c}) is mapped by a neural network onto a corresponding latent observation rₙ. (For the sake of simplicity, task indices/are omitted in the following.) A permutation-invariant operation is then performed on generated set {rₙ}ₙ₌₁^{N}, in order to obtain an aggregated, latent observation r̅. One of the options used in this connection in the related art is calculating a mean, namely r̅=1/N·Σₙ₌₁^{N}rₙ. It must be taken into consideration, that this aggregated observation r̅ is then used, in order to parameterize a corresponding distribution for latent variables z.

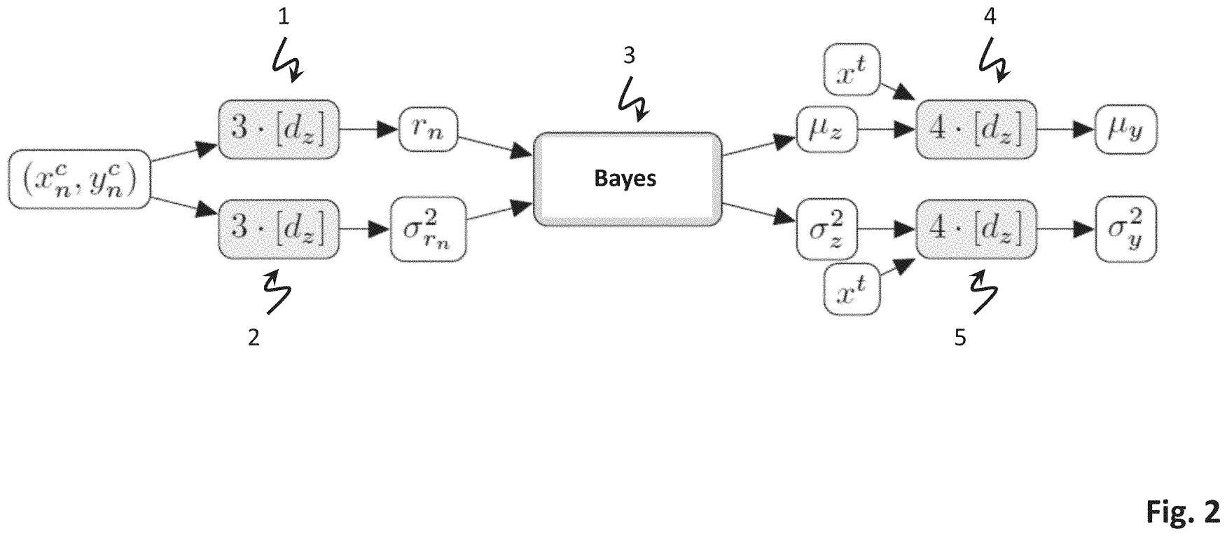

As is shown in FIG. 2, an aggregation described here, which is calculated for a plurality of latent variables z in view of training data set (xₙ^{c},yₙ^{c}), may be formulated, for example, as a Bayesian inference problem. In one example, the training data set (xₙ^{c},yₙ^{c}) received may reflect a dynamic response of the device. In contrast to the aggregation mechanisms used in the related art, the present method, which is based on the aggregation that uses Bayesian inference (in short, “Bayesian aggregation”), may allow the information contained in the training data set to be transferred directly into a statistical description of the plurality of latent variables z. As discussed further down, in particular, the parameters, which parameterize a corresponding distribution with regard to the plurality of latent variables z, will not be based on a rough mean aggregation r̅ for aggregated latent observations rₙ, which is used traditionally in the related art. The aggregation step of the present invention may improve the entire method and result in the generation of an efficient computer-implemented machine learning system, due to the generation of an a-posteriori predictive distribution p(y|x, [symbol] ^{c}) for predicting the dynamic response of the device, using the computed “Bayesian aggregation,” and under the condition that the training data set (xₙ^{c},yₙ^{c}) has set in. The computational costs resulting from that may be reduced considerably, as well. The a-posteriori predictive distribution generated by this method may advantageously be used for predicting corresponding output variables as a function of input variables regarding the dynamic response of the controlled device.

A plurality of training data sets may include input variables measured on the device and/or calculated for the device. The plurality of training data sets may include information with regard to operating states of the technical device. In addition, or as an alternative, the plurality of training data sets may include information items regarding the surroundings of the technical device. In some examples, the plurality of training data sets may include sensor data. The computer-implemented machine-learning system may be trained for a certain technical device, in order to process data (e.g., sensor data) produced in this device and/or in its surrounding area and to calculate one or more output variables relevant to the monitoring and/or control of the device. This may occur during the design of the technical device. In this case, the computer-implemented machine learning system may be used for calculating the corresponding output variables as a function of the input variables. The acquired data may then be added to a monitoring and/or control device for the technical device. In other examples, the computer-implemented machine learning system may be used during operation of the technical device, in order to carry out monitoring and/or control tasks.

According to the definition above, the training data sets may also be referred to as context data sets, [symbol] ₗ^{c}, see also FIG. 1a. The training data set (xₙ^{c},yₙ^{c}) used in the present description (e.g., for a selected index l where l=1 . . . L) may include the plurality of training data points and be made up of a first plurality of data points xₙ^{c} and a second plurality of data points yₙ^{c}. By way of example, using a given subset of functions from a general, given family of functions [symbol] , the second plurality of data points, yₙ^{c}, may be calculated on the first plurality of data points xₙ^{c}, in the same manner as discussed further above. For example, family of functions [symbol] may be selected in such a manner, that it is the most suitable for describing an operating state of a particular device considered. The functions and, in particular, the given subset of functions, may also possess a similar statistical structure.

In the next step of the method, and in accordance with the discussions above, each pair of the first plurality of data points xₙ^{c} and of the second plurality of data points yₙ^{c} from training data set (xₙ^{c},yₙ^{c}) may be mapped by a first neural network 1 onto a corresponding latent observation rₙ. In addition to the initiated mapping onto corresponding latent observation rₙ, in one example, each context data pair may be mapped by a second neural network 2 onto an uncertainty σᵣ_{ₙ}² of corresponding latent observation rₙ. A Bayesian a-posteriori distribution p(z|rₙ) for the plurality of latent variables z may then be aggregated (e.g., with the aid of an appropriately configured module 3), under the condition that the plurality of latent observations rₙ has set in. In this connection, an example of a method includes updating the a-posteriori distribution, using Bayesian inference. For example, a Bayesian inference calculation of the following form may be carried out: p(z|rₙ)=p(rₙ|z)·p(z)/p(rₙ) Ultimately, a plurality of latent observations rₙ and a plurality of their uncertainties σᵣ_{ₙ}², may be calculated, see also FIG. 2. As already mentioned further above, the method of the present invention differs primarily from the traditional methods in that from the beginning, the first uses two neural networks for the mapping step, while the latter include only one neural network and rough mean aggregation r for aggregated latent observations rₙ. In this manner, the information contained in the training data set may be transferred directly into the statistical description of the plurality of latent variables.

In one example, the “Bayesian aggregation” may be implemented with the aid of factored Gaussian distributions. A corresponding likelihood distribution p(rₙ|z) may be defined, for example, by a specific Gaussian distribution as follows: p(rₙ|z)= [symbol] (rₙ|z,σᵣ_{₂}²). In this case, uncertainty σᵣ_{ₙ}² corresponds to a variance of the corresponding Gaussian distribution.

The method of the present description may include the generation of a second approximate a-posteriori distribution q_{φ}(z| [symbol] ^{c}) for the plurality of latent variables z, under the condition that training data set (xₙ^{c},yₙ^{c}) has set in. In the above case of factored Gaussian distributions [symbol] (rₙ|z,σᵣ_{ₙ}²), this second approximate a-posteriori distribution may be described by a set of parameters μ_{z};σ_{z}², which may be parameterized over a parameter φ common to the training data set. This set of parameters μ_{z}; σ_{z}² may be calculated iteratively on the basis of the calculated plurality of latent observations rₙ and the calculated plurality of their uncertainties σᵣ_{ₙ}². In summary, the formulation of the aggregation as Bayesian inference allows the information included in training data set [symbol] ^{c}≡(xₙ^{c},yₙ^{c}) to be transferred directly into the statistical description of latent variables z.

In addition, the iterative calculation of the set of parameters of second approximate a-posteriori distribution q_{φ}(z| [symbol] ^{c}) may include implementing another plurality of factored Gaussian distributions with regard to latent variables z. In this example, the set of parameters may correspond to a plurality of means μ_{z} and variances σ_{z}² of the Gaussian distributions.

In addition, the method includes receiving another training data set (xₙ^{t},yₙ^{t}), which includes a third plurality of data points xₙ^{t} and a fourth plurality of data points yₙ^{t}. The other training data set may also correspond to a target data set mentioned further above, [symbol] ^{t}≡(xₙ^{t},yₙ^{t}) (see also FIG. 1a). By way of example, the present method includes calculating the fourth plurality of data points yₙ^{t}, using the same given subset of functions from the general, given family of functions [symbol] ; the given subset of functions being calculated on the third plurality of data points xₙ^{t}. The method further includes generating a third distribution p (yₙ^{t}|μ_{z},σ_{z}²,xₙ^{t},θ), which is a function of the plurality of latent variables z, set of parameters (μ_{z};σ_{z}²), task-independent variables θ, and other training data set (xₙ^{t},yₙ^{t}) (e.g., target data set). In a preferred example, this third distribution p(yₙ^{t}|μ_{z}, σ_{z}², xₙ^{t}, θ) may be generated by a third and fourth neural network 4, 5.

A next step of the method includes optimizing a likelihood distribution p (yₙ^{t}|xₙ^{t}, [symbol] ^{c},θ) with regard to task-independent variable θ and to common parameter φ. In a first example, the optimizing of likelihood distribution p(yₙ^{t}|xₙ^{t}, [symbol] ^{c}, θ) may include maximizing likelihood distribution p(yₙ^{t}|xₙ^{t}, [symbol] ^{c}, θ) with regard to task-independent variable θ and to common parameter φ. Here, the maximization may be based on the second approximate a-posteriori distribution q_{φ}(z| [symbol] ^{c}) generated and on the third distribution p(yₙ^{t}|μ_{Z}, σ_{z}², xₙ^{t}, θ) generated. In this connection, maximizing likelihood distribution p(yₙ^{t}|xₙ^{t}, [symbol] ^{c}, θ) may further include computing an integral over a function of latent variables z, which contains the respective products of second approximate a-posteriori distribution q_{φ}(z| [symbol] ^{c}) and third distribution p(yₙ^{t}|μ_{z}, σ_{z}², xₙ^{t}, θ).

In order to optimize task-independent variable θ and common parameter φ, using the maximization of likelihood distribution p(yₙ^{t}|xₙ^{t}, [symbol] ^{c}, θ), the integral may be approximated with regard to the plurality of latent variables z. To this end, the integral may be approximated with regard to the plurality of latent variables z, using a non-stochastic loss function, which is based on the set of parameters μ_{z}; σ_{z}² of second approximate a-posteriori distribution q_{φ}(z| [symbol] ^{c}). In this manner, the entire method may be computed more rapidly than some methods of the related art, which use traditional variational-inference-based or Monte-Carlo-based methods. Finally, the task-independent variables θ derived via the optimization and common parameter φ may be used in likelihood distribution p(yₙ^{t}|xₙ^{t}, [symbol] ^{c}, θ), in order to generate a-posteriori predictive distribution p(y|x, [symbol] ^{c}).

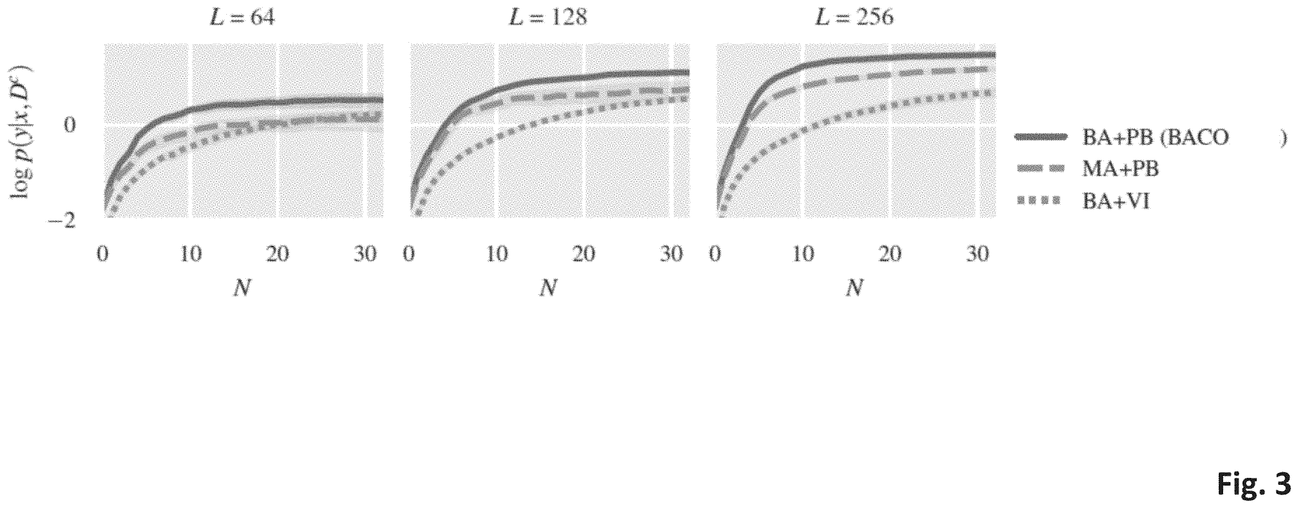

The results for a standard problem (the Furuta pendulum), which have been computed for different methods, are compared in FIG. 3. This figure shows logarithms of a-posteriori predictive distribution, log p(y|x, [symbol] ^{c}), as a function of the first plurality of data points (that is, of the number of context data points) N. As is apparent from this figure, the method of the present description may improve the overall performance of the computer-implemented machine learning system in comparison with the corresponding traditional methods, namely, mean aggregation (MA) and/or likelihood variation methods (VI), in particular, in the case of small training data sets.

As discussed further above, the computer-implemented machine learning systems of this description may be used in different technical devices and systems. For example, the computer-implemented machine learning systems may be used for controlling and/or monitoring a device.

A first example relates to the design of a technical device or a technical system. In this connection, the training data sets may include measurement data and/or synthetic data and/or software data, which are relevant to the operating states of the technical device or of a technical system. The input and/or output data may be state variables of the technical device or of a technical system and/or controlled variables of the technical device or of a technical system. In one example, generating the computer-implemented probabilistic machine learning system (e.g., a probabilistic regressor or classifier) may include mapping an input vector of a dimension ( [symbol] ⁿ) to an output vector of a second dimension ( [symbol] ^{m}). In this case, for example, the input vector may represent elements of a time series for at least one measured input state variable of the device. The output vector may represent at least one estimated output state variable of the device, which is predicted with the aid of the a-posteriori predictive distribution generated. In one example, the technical device may be a machine, e.g., an engine (e.g., a combustion engine, an electric motor, or a hybrid engine). In other examples, the technical device may be a fuel cell. In one example, the measured input state variable of the device may include a rotational speed, a temperature or a mass flow rate. In other examples, the measured input state variable of the device may include a combination of them. In one example, the estimated output state variable of the device may include a torque, an efficiency, or a compression ratio. In other examples, the estimated output state variable may include a combination of them.

In a technical device, the different input and output variables may have complex nonlinear functional relationships during operation. In one example, parameterization of a characteristics map for the device (e.g., for an internal combustion engine, an electric motor, a hybrid engine, or a fuel cell) may be modeled with the aid of the computer-implemented machine learning systems of this description. The modeled characteristics map of the method according to the present invention allows, above all, the correct relationships between the different state variables of the device during operation to be supplied rapidly and accurately. For example, the characteristics map modeled in this manner may be used during the operation of the device (e.g., of the engine), for monitoring and/or controlling the engine (for example, in an engine control unit). In one example, the characteristics map may indicate how a dynamic response (e.g., a power consumption) of a machine (e.g., of an engine) is a function of different state variables of the machine (e.g., rotational speed, temperature, mass flow rate, torque, efficiency, and compression ratio).

The computer-implemented machine learning systems may be used for classifying a time series, in particular, for classifying image data (this means that the technical device is an image classifier). The image data may include, for example, camera, lidar, radar, ultrasonic, or thermal image data (e.g., generated by corresponding sensors). In some examples, the computer-implemented machine learning systems may be designed for a monitoring device (for example, a manufacturing method and/or for quality assurance) or for a medical imaging system (for example, for the results of diagnostic data), or may be used in such a device.

In other examples (or in addition), the computer-implemented machine learning systems may be designed or used for monitoring the operating state and/or the surrounding area of an at least semiautonomous robot. The at least semiautonomous robot may be an autonomous vehicle (or another at least semiautonomous propulsive or transport device). In other examples, the at least semiautonomous robot may be an industrial robot. In other examples, the technical device may be a machine or a group of machines (e.g., an industrial plant). For example, an operating state of a machine tool may be monitored. In these examples, the output data y may include information regarding the operating state and/or the surrounding area of the respective technical device.

In further examples, the system to be monitored may be a communications network. In some examples, the network may be a telecommunications network (e.g., a 5-G network). In these examples, the input data x may include capacity utilization data at nodes of the network, and the output data y may include information regarding the allocation of resources (e.g., channels, bandwidth in channels of the network, or other resources). In other examples, a network malfunction may be detected.

In other examples (or in addition), the computer-implemented machine learning systems may be configured or used to control (or regulate) a technical device. The technical device may be, in turn, one of the devices discussed above (or below) (e.g., an at least semiautonomous robot or a machine). In these examples, output data y may include a controlled variable of the specific technical system.

In other examples (or in addition), the computer-implemented machine learning systems may be configured or used to filter a signal. In some cases, the signal may be an audio signal or a video signal. In these examples, output data y may include a filtered signal.

The methods for generating and using computer-implemented machine learning systems of the present description may be executed on a computer-implemented system. The computer-implemented system may include at least one processor, at least one storage device (which may contain programs that, when executed, carry out the methods of the present description), as well as at least one interface for inputs and outputs. The computer-implemented system may be a stand-alone system or a distributed system, which communicates via a network (e.g., the Internet).

The present description also relates to computer-implemented machine learning systems, which are generated by the methods of the present description. The present description also relates to computer programs, which are configured to execute all of the steps of the methods of the present description. Furthermore, the present description relates to machine-readable storage media (e.g., optical storage media or fixed storage, for example, flash memory), in which computer programs are stored that are configured to execute all of the steps of the methods according to the present invention.

What is claimed is:

1. A computer-implemented method for generating a computer-implemented machine learning system, the method includes the following steps:
receiving a training data set, which reflects a dynamic response of a device;
computing an aggregation of at least one latent variable of the machine learning system, using Bayesian inference, and in view of the training data set, an information item contained in the training data set being transferred directly into a statistical description of the plurality of latent variables; and
generating an a-posteriori predictive distribution for predicting the dynamic response of the device, using the calculated aggregation, and under a condition that the training data set has set in.

2. The computer-implemented method as recited in claim 1, further comprising:
using the a-posteriori predictive distribution generated for predicting corresponding output variables as a function of input variables regarding the dynamic response of the device.

3. The computer-implemented method as recited in claim 1,
wherein the training data set includes a first plurality of data points and a second plurality of data points, and the method includes calculating the second plurality of data points, using a given subset of functions from a general, given family of functions, the given subset of functions is calculated on the first plurality of data points, wherein computing the aggregation includes the following steps:
mapping each pair of the first plurality of data points and of the second plurality of data points from the training data set onto a corresponding latent observation, using a first neural network, and onto an uncertainty of the corresponding latent observation, using a second neural network;
aggregating a Bayesian a-posteriori distribution for the plurality of latent variables under a condition that the plurality of latent observations has set in, the aggregating being carried out, using Bayesian inference, through which information contained in the training data set is transferred directly into the statistical description of the plurality of latent variables; and
calculating a plurality of latent observations and a plurality of their uncertainties.

4. The computer-implemented method as recited in claim 3, wherein aggregating the Bayesian a-posteriori distribution includes implementing a plurality of factored Gaussian distributions, wherein each uncertainty is a variance of a corresponding Gaussian distribution.

5. The computer-implemented method as recited in claim 4, wherein generating the a-posteriori predictive distribution includes the following further steps:
generating a second approximate a-posteriori distribution for the plurality of latent variables under a condition that the training data set has set in, the second approximate a-posteriori distribution being further described by a set of parameters, which is parameterized over a parameter common to the training data set;
iteratively calculating the set of parameters based on the calculated plurality of latent observations and the calculated plurality of their uncertainties.

6. The computer-implemented method as recited in claim 5,
wherein iteratively calculating the set of parameters includes implementing another plurality of factored Gaussian distributions with regard to the latent variables, and the set of parameters corresponds to a plurality of means and variances of the Gaussian distributions.

7. The computer-implemented method as recited in claim 5, further comprising:
receiving another training data set, which includes a third plurality of data points and a fourth plurality of data points;
calculating the fourth plurality of data points, using the given subset of functions from the general, given family of functions, the given subset of functions is calculated on the third plurality of data points;
and wherein generating the a-posteriori predictive distribution further includes generating a third distribution, using a third and fourth neural network, wherein the third distribution is a function of the plurality of latent variables, the set of parameters, task-independent variables, and the other training data set.

8. The computer-implemented method as recited in claim 7, wherein generating the a-posteriori predictive distribution includes optimizing a likelihood distribution with regard to the task-independent variables and the common parameter.

9. The computer-implemented method as recited in claim 8, wherein optimizing the likelihood distribution includes maximizing the likelihood distribution with regard to the task-independent variables and the common parameter, and the maximizing is based on the second approximate a-posteriori distribution generated and on the third distribution generated.

10. The computer-implemented method as recited in claim 9, wherein maximizing the likelihood distribution includes calculating an integral over a function of latent variables, which contains respective products of the second approximate a-posteriori distribution and of the third distribution.

11. The computer-implemented method as recited in claim 10, wherein calculating the integral includes approximating the integral with regard to the plurality of latent variables, using a non-stochastic loss function, which is based on the set of parameters of the second approximate a-posteriori distribution.

12. The computer-implemented method as recited in claim 8, further comprising substituting the task-independent variables derived by the optimization, and the common parameter, in the likelihood distribution, in order to generate the a-posteriori predictive distribution.

13. The computer-implemented method as recited in claim 1, wherein generating the computer-implemented machine learning system includes mapping an input vector of a dimension to an output vector of a second dimension, the input vector represents elements of a time series for at least one measured input state variable of the device, and the output vector represents at least one estimated output state variable of the device, which is predicted using the a-posteriori predictive distribution generated.

14. The computer-implemented method as recited in claim 1, wherein the device is a machine.

15. The computer-implemented method as recited in claim 14, wherein the device is an engine.

16. The computer-implemented method as recited in claim 1, wherein the computer-implemented machine learning system is configured for modeling parameterization of a characteristics map of the device.

17. The computer-implemented method as recited in claim 16, further comprising parameterizing a characteristics map of the device, using the computer-implemented machine learning system generated.

18. The computer-implemented method as recited in claim 13, wherein the training data sets includes input variables measured on the device and/or calculated for the device, the at least one input variable of the device includes at least one of a rotational speed, or a temperature, or a mass flow rate, and the at least one estimated output state variable of the device includes at least one of a torque, or an efficiency, or a compression ratio.

19. A computer-implemented system for generating and/or using a computer-implemented machine learning system, the computer-implemented machine learning system being trained by:
receiving a training data set, which reflects a dynamic response of a device;
computing an aggregation of at least one latent variable of the machine learning system, using Bayesian inference, and in view of the training data set, an information item contained in the training data set being transferred directly into a statistical description of the plurality of latent variables; and
generating an a-posteriori predictive distribution for predicting the dynamic response of the device, using the calculated aggregation, and under a condition that the training data set has set in.
